(19) United States
(12) Patent Application Publication
(10) Pub. No.: US 2020/0334805 A1
(43) Pub. Date: Oct. 22, 2020

(54) INFORMATION PROCESSING METHOD, INFORMATION PROCESSING PROGRAM, AND INFORMATION PROCESSING SYSTEM

(71) Applicant: 3M INNOVATIVE PROPERTIES COMPANY, St. Paul, MN (US)

(72) Inventors: Yukari Sekiya, Tokyo (JP); Shingo Moriyasu, Tokyo (JP)

(21) Appl. No.: 16/959,879

(22) PCT Filed: Jan. 3, 2019
(86) PCT No.: PCT/IB19/50058

§ 371 Date: Jul. 2, 2020

(30) Foreign Application Priority Data
Jan. 5, 2018 (JP) 2018-000556

(51) Int. Cl. G06T 7/00; G06T 7/11

(52) U.S. Cl. CPC G06T 7/0002; G06T 7/11

(57) ABSTRACT

An information processing method that can more simply determine the extent of adhesion of an adhered surface. The information processing method that includes calculating a first region area of a first determination region and a first wetted area of the first determination region by analyzing an image in which the first determination region of an adhered surface is projected; determining a first degree of adhesion in the first determination region based on the first region area and the first wetted area; and outputting determination information on the determined first degree of adhesion.

### TECHNICAL FIELD

The present invention relates to an information processing method, an information processing program, and an information processing system for determining the adhesion status of articles.

### BACKGROUND ART

Determining the degree of adhesion of an adhered surface is an example of a means for verifying the certainty of adhesion between articles. For example, Patent Document JP S62-168032 A describes a method for measuring the adhesion area of adhesive tape. This measurement method includes measuring, among the physical properties of an adhesive agent of an adhesive tape, viscoelastic characteristics, and dynamically analyzing a deformation status of an elastic body, relative to an uneven adhered surface under prescribed pressure bonding conditions when an adhesive layer of the adhesive tape is made into a continuous body having those measured viscoelastic characteristics.

### SUMMARY OF THE INVENTION

With the technique described in Patent Document JP S62-168032 A, the process is complex because it is necessary to measure the quantity of reflected light from the sticky surface of the adhesive tape using a rectangular prism and to take into consideration numerous physical properties or characteristics. Thus, it has been desired to more simply determine the extent of adhesion of an adhered surface.

The information processing method according to one aspect of the present invention is an information processing method executed by a processor, the method including calculating a first region area of a first determination region and a first wetted area of the first determination region by analyzing an image in which the first determination region of an adhered surface is projected; determining a first degree of adhesion in the first determination region based on the first region area and the first wetted area; and outputting determination information on the determined first degree of adhesion.

The information processing program according to one aspect of the present invention is an information processing program executed in a computer system, the program including calculating a first region area of a first determination region and a first wetted area of the first determination region by analyzing an image in which the first determination region of an adhered surface is projected; determining a first degree of adhesion in the first determination region based on the first region area and the first wetted area; and outputting determination information on the determined first degree of adhesion.

The information processing system according to one aspect of the present invention includes an analysis unit configured to calculate a first region area of a first determination region and a first wetted area of the first determination region by analyzing an image in which the first determination region of an adhered surface is projected; a determination unit configured to determine a first degree of adhesion in the first determination region based on the first region area and the first wetted area; and an output unit configured to output determination information on the determined first degree of adhesion.

In this aspect, by just preparing an image in which the region of the adhered surface that is the subject of determination (first determination region) is projected, the degree of adhesion of that region is determined based on that image. Thus, the extent of adhesion of an adhered surface can be more simply determined.

According to one aspect of the present invention, the extent of adhesion of an adhered surface can be more simply determined.

### BRIEF DESCRIPTION OF THE DRAWINGS

FIG. 1 is a diagram illustrating an example of a hardware configuration of an information processing system according to an embodiment.

FIG. 2 is a diagram illustrating an example of a functional configuration of an information processing system according to an embodiment.

FIG. 3 is a flowchart illustrating an example of the operation of an information processing system according to an embodiment.

FIG. 4 is a flowchart illustrating an example of the operation of an information processing system according to an embodiment.

FIG. 5 is a flowchart illustrating an example of the operation of an information processing system according to an embodiment.

FIG. 6 is a drawing illustrating an example of an analyzed image.

FIG. 7 is a drawing illustrating an example of an interface that accepts a second determination region.

FIG. 8 is a drawing illustrating an example of display of determination information.

FIG. 9 is a drawing illustrating an example of display of determination information.

FIG. 10 is a drawing illustrating an example of display of determination information.

FIG. 11 is a drawing illustrating an example of display of determination information.

FIG. 12 is a drawing illustrating a configuration of an information processing program according to an embodiment.

### DESCRIPTION OF EMBODIMENTS

Detailed descriptions of embodiments according to the present invention are given below with reference to the attached drawings. Note that identical elements are assigned identical reference signs in the description of the drawings, and duplicate descriptions are omitted. System configuration

An information processing system 10 according to an embodiment is a computer system used for determining the adhesion status between articles. The type of article that is the subject of determination is not limited in any way. The adhesive agent for adhering the articles to each other is also not limited in any way, and may be, for example, a liquid adhesive agent or an adhesive tape. Determination of adhesion status is the process of determining how securely articles are adhered to each other.

The type and configuration of the device functioning as the information processing system 10 are not limited. For example, the information processing system 10 may be constituted of a single computer, for example, a portable device such as a tablet, smart phone, or laptop personal computer, or a desktop personal computer. Alternatively, the information processing system 10 may be a distributed processing system constituted of a plurality of computers, for example, a client-server system or a cloud system.

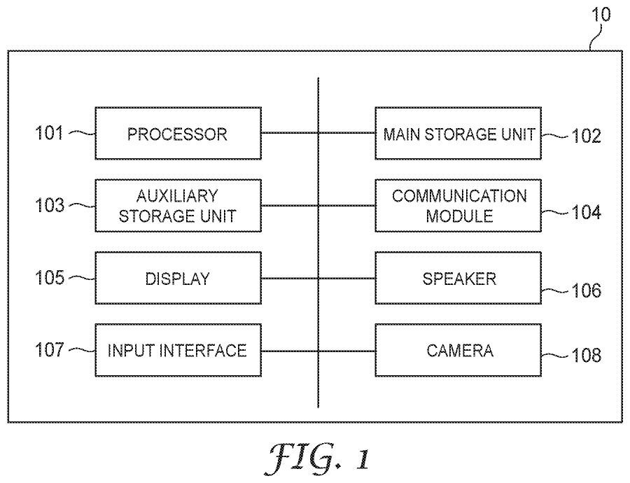

FIG. 1 is a drawing illustrating an example of a hardware configuration of the information processing system 10. For example, the information processing system 10 includes a processor 101, a main storage unit 102, an auxiliary storage unit 103, a communication module 104, a display 105, a speaker 106, an input interface 107, and a camera 108. The processor 101 is a computation unit which executes an operating system and application programs. The main storage unit 102 is constituted of ROM and RAM. It temporarily stores loaded programs, computation results, and the like. The auxiliary storage unit 103 is constituted of a flash memory or a hard disk. It perpetually stores programs or data. The communication module 104 is constituted of a wireless communication module, a network card, and the like. It executes data transmission and reception with other computers. The display 105 is an apparatus that is constituted of a touch screen or a monitor and displays data or information so that a user can see it. The speaker 106 is an apparatus that outputs data or information by audio so that a user can hear it. The input interface 107 is an apparatus that is constituted of a touch screen, keyboard, mouse, or the like and accepts data or instructions input by a user. The camera 108 is an apparatus that produces images (still images or video) by photography.

Each of the functional elements of the information processing system 10 is realized by reading prescribed software (for example, the information processing program P described below) on the processor 101 or the main storage unit 102 and executing that software. According to the software, the processor 101 operates the communication module 104, the display 105, the speaker 106, the input interface 107, or the camera 108 and reads or writes data in the main storage unit 102 or auxiliary storage unit 103. The data or database required for processing is stored in the main storage unit 102 or the auxiliary storage unit 103.

As stated above, the information processing system 10 may be constituted of one computer or a plurality of computers. In a case where a plurality of computers are used, an information processing system 10 which is logically one system is established by connecting the computers via a communication network such as the internet or an intranet.

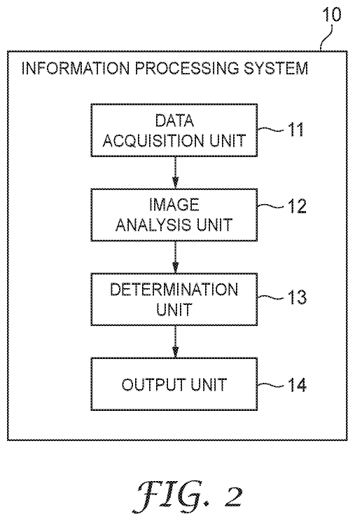

FIG. 2 is a drawing illustrating an example of the functional configuration of the information processing system 10. As functional constituent elements, the information processing system 10 includes a data acquisition unit 11, an image analysis unit 12, a determination unit 13, and an output unit 14. In other words, the processor 101 functions as a data acquisition unit 11, an image analysis unit 12, a determination unit 13, and an output unit 14.

The data acquisition unit 11 is a functional element that acquires the data necessary for determining the adhesion status of the articles. Specifically, the data acquisition unit 11 acquires an image in which the determination region of an adhered surface is projected. An adhered surface is a surface of an adherend that contacts another article by adhesion. A determination region is a region that is the subject to determine the adhesion status. The data acquisition unit 11 may acquire two determination regions, namely a first determination region and a second determination region which is a portion of the first determination region. The first determination region may be an entirety of the adhered surface or a portion of the adhered surface. In either case, the second determination region is a portion of the first determination region. The data acquisition unit 11 may acquire another data in addition to images; for example, it may acquire adhesion test conditions.

The image analysis unit 12 is a functional element that calculates the area of a determination region (region area), the wetted area of the determination region, and the non-wetted area of the determination region by analyzing an image in which the determination region of an adhered surface is projected. A wetted area is the area of a region actually joined to another article via an adhesive agent (this is called a “wetted region”). A non-wetted area is the area of a region not joined to another article via an adhesive agent (this is called a “non-wetted region”). The present specification employs two concepts each for the wetted region and the non-wetted region. The two concepts correspond to two determination regions, namely the first and second determination regions. Specifically, a wetted region present within the first determination region is called a first wetted region, and a wetted region present within the second determination region is called a second wetted region. Furthermore, a non-wetted region present within the first determination region is called a first non-wetted region, and a non-wetted region present within the second determination region is called a second non-wetted region.

The determination unit 13 is a functional element that determines the degree of adhesion in a determination region. The degree of adhesion is an index of adhesion status. More specifically, it is an index indicating how securely articles are adhered to each other in the determination region. The determination unit 13 determines the degree of adhesion based on the area of the region, the wetted area, or the non-wetted area.

The output unit 14 is a functional element that outputs determination information on the determined degree of adhesion. The determination information related to the degree of adhesion is information that may include both the degree of adhesion itself and optional information based on the degree of adhesion. The determination information may also be information that directly or indirectly indicates how securely articles are adhered to each other in the determination region. The format of determination information is not limited. For example, the determination information may be expressed by text, images, symbols, colors, or any combination thereof The method for outputting determination information is not limited. For example, the output unit 14 may display determination information on the display 105, and may output it by audio from the speaker 106. Alternatively, the output unit 14 may transmit determination information to another computer.

### System Operation

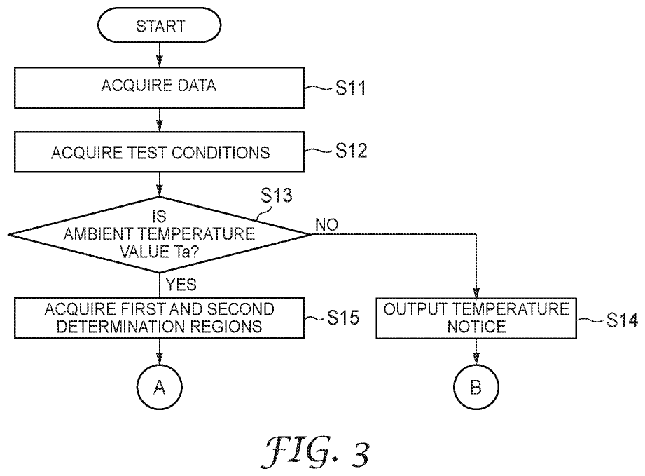

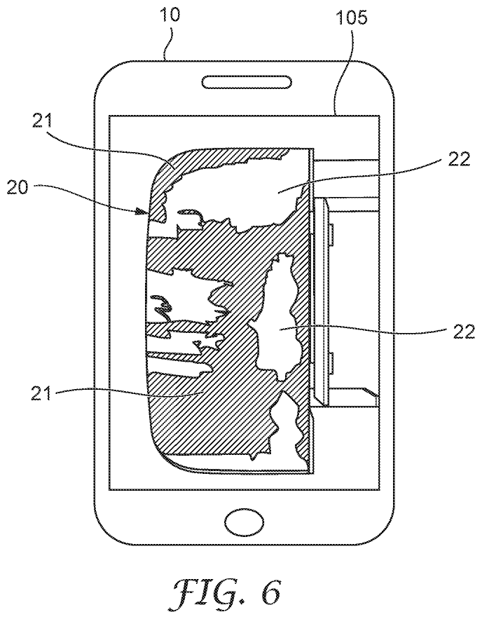

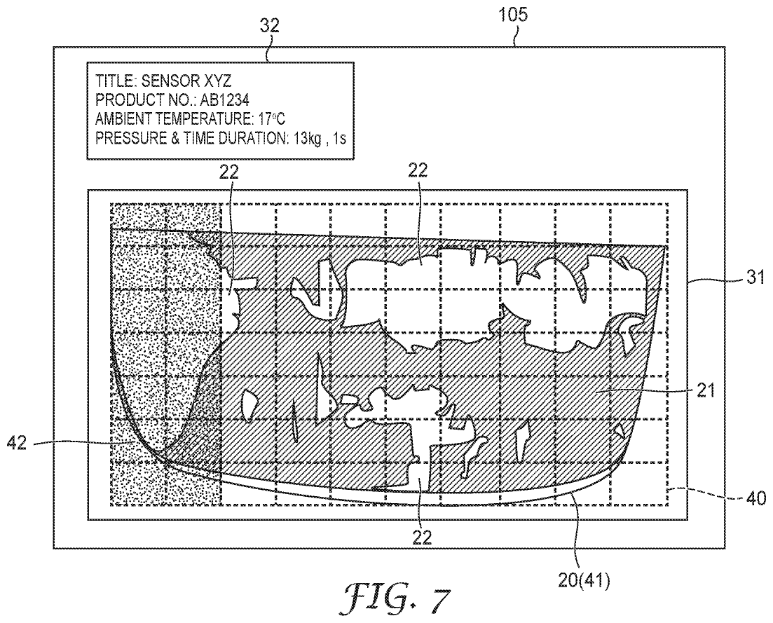

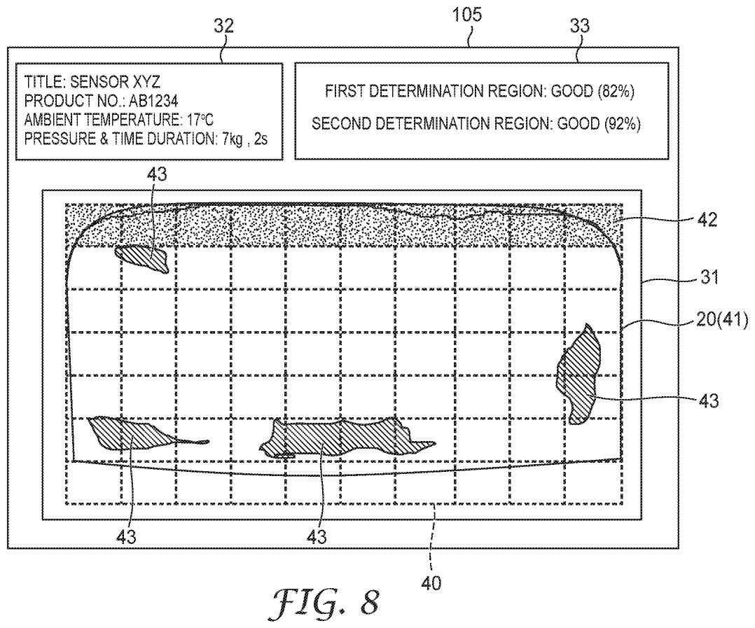

The operation of the information processing system 10 as well as the information processing method according to the present embodiment will be described in reference to FIGS. 3 to 11. FIGS. 3 to 5 are flowcharts illustrating examples of the operation of the information processing system 10. FIG. 6 is a drawing illustrating an example of an analyzed image. FIG. 7 is a drawing illustrating an example of an interface that accepts the second determination region. FIGS. 8 to 11 are drawings illustrating examples of determination information.

In step S11, the data acquisition unit 11 acquires an image in which the determination region of the adhered surface is projected. The method of acquiring the image is not limited. For example, the data acquisition unit 11 may acquire an image obtained from the camera 108, may receive an image from another computer, or may read an image from the auxiliary storage unit 103. The format of the image is not limited. For example, the format of the image may be a still image, or may be data corresponding to one frame of video data.

To determine a wetted region in image analysis, the user applies an adhesive agent to the adhered surface of one adherend and coats the adhered surface of another adherend with a paint, and then adhere the two adhered surfaces together, and then separates the two adherends after a predetermined duration. At this time, the paint transfers to the adhesive agent in the wetted regions of the adhered surface of one of the adherends, and the paint does not transfer to the adhesive agent in the non-wetted regions. Thus, it is possible to optically capture (for example, visually or photographically) the wetted regions and the non-wetted regions. FIG. 6 illustrates a situation where an image of the analysis subject taken by the camera 108 is displayed on the display 105. The substantially rectangular adhered surface 20 projected in this image includes both wetted regions 21 and non-wetted regions 22. For example, the data acquisition unit 11 acquires the image as illustrated in FIG. 6.

Returning to FIG. 3, in step S12, the data acquisition unit 11 acquires test conditions. The method of acquiring the test conditions is not limited. For example, the data acquisition unit 11 may acquire test conditions input via the input interface 107, or may acquire data detected by optional devices (for example, sensors) mounted on the information processing system 10 as test conditions. Alternatively, the data acquisition unit 11 may receive test conditions from another computer, or may read test conditions from the auxiliary storage unit 103. The data items of test conditions are not limited, and may include any type of information. For example, the test conditions may include information on the adherend or may contain information on adhesion conditions. Information on the adherend may be, for example, a product name, model number, product number, serial number, material, shape, dimensions, or any combination of these attributes. Adhesion conditions are the conditions at the time when the adhered surface shown in the image was adhered to the other article. For example, adhesion conditions may be ambient temperature (air temperature surrounding the adherend), pressure applied to the adhered surface, duration for which the pressure was applied, type or quantity of adhesive agent, or any combination of these attributes. For example, the data acquisition unit 11 acquires test conditions including a title, product number, ambient temperature, pressure applied to the adhered surface, duration for which the pressure was applied, and a memo.

In step S13, the data acquisition unit 11 compares the ambient temperature with a threshold value Ta. This comparison is one example of a technique for determining whether the adhesion operation has been performed in a suitable environment. The threshold value Ta may be set to any value; for example, 15° C.

When the ambient temperature is less than the threshold value Ta (NO in step S13), in step S14, the data acquisition unit 11 outputs a temperature notice and ends the process. The temperature notice is information indicating that the degree of adhesion is not determined because the ambient temperature is not suitable for testing adhesion. For example, the temperature notice may be a message indicating “Raise the ambient temperature to at least 15° C.” The method for outputting the temperature notice is not limited. For example, the data acquisition unit 11 may display the temperature notice on the display 105, and may output the temperature notice by audio from the speaker 106. Alternatively, the data acquisition unit 11 may transmit the temperature notice to another computer. Output of a predetermined temperature notice to the user of the information processing system 10 can promote the user to retry adhesion.

When the ambient temperature is greater than or equal to the threshold value Ta (YES in step S13), in step S15, the data acquisition unit 11 acquires a first determination region and a second determination region. In the present embodiment, the data acquisition unit 11 acquires the entirety of the adhered surface 20 as the first determination region and acquires a portion of the first determination region as the second determination region based on user input.

FIG. 7 illustrates an example of an interface for accepting an input of the second determination region. In this example, the data acquisition unit 11 displays an image 31 of the adhered surface 20 and test conditions 32 on the display 105, and displays a virtual grid 40 superimposing the image 31 on the display 105. The respective blocks that constitute the virtual grid 40 can be selected by the user. For example, the user may select or deselect a desired block by tracing over it. For example, the user selects a particularly important portion on the adhered surface 20. In the example of FIG. 7, the data acquisition unit 11 acquires the entirety of the adhered surface 20 as the first determination region 41, and acquires the two left columns (7×2 block group) of the virtual grid 40 as the second determination region 42.

The method of acquiring the second determination region is not limited to the virtual grid 40, and the data acquisition unit 11 may acquire the second determination region by any technique. For example, the data acquisition unit 11 may acquire a region within a frame drawn by a user using a pointing device on the image 31 as the second determination region.

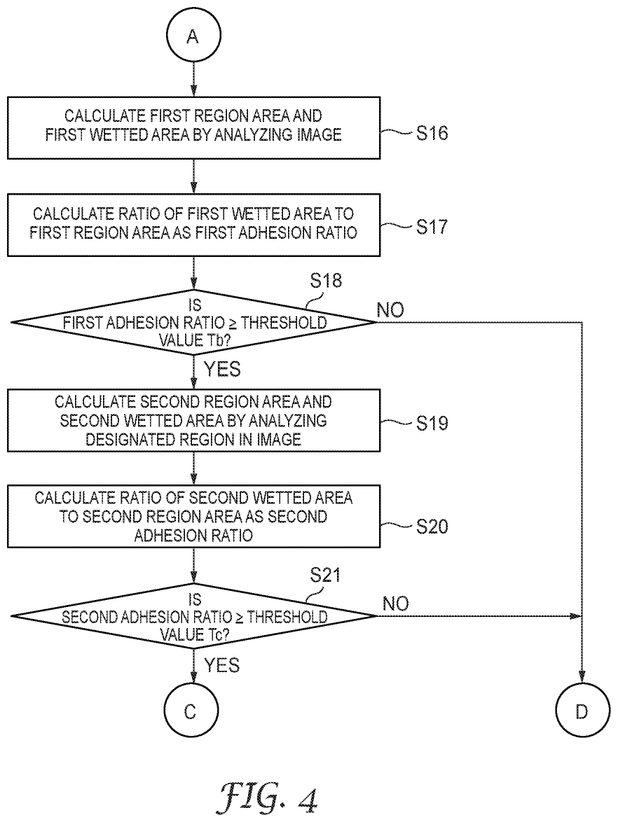

As illustrated in FIG. 4, in step S16, the image analysis unit 12 determines the first determination region 41 and the first wetted region by analyzing the image 31. Then, the image analysis unit 12 calculates the first region area, which is the area of the first determination region 41, and the first wetted area, which is the total of the areas of one or more first wetted regions. In step S17, the determination unit 13 calculates the ratio of the first wetted area to the first region area as a first adhesion ratio.

In step S18, the determination unit 13 compares the first adhesion ratio with a threshold value Tb. This comparison is an example of determining the first degree of adhesion, which is the degree of adhesion in the first determination region. The threshold value Tb may set to any value; for example, 80%.

When the first adhesion ratio is greater than or equal to the threshold value Tb (YES in step S18), in step S19, the image analysis unit 12 determines the second determination region 42 and the second wetted region based on analysis of the image 31 and user input via the virtual grid 40. Then, the image analysis unit 12 calculates the second region area, which is the area of the second determination region 42, and the second wetted area, which is the total of the areas of one or more second wetted regions.

In step S20, the determination unit 13 calculates the ratio of the second wetted area to the second region area as a second adhesion ratio.

In step S21, the determination unit 13 compares the second adhesion ratio with a threshold value Tc. This comparison is an example of determining the second degree of adhesion, which is the degree of adhesion in the second determination region. The threshold value Tc may set to any value; for example, 80%. The threshold value Tc may be the same as or different than the threshold value Tb.

When the second adhesion ratio is greater than or equal to the threshold value Tc (YES in step S21), in step S22, the image analysis unit 12 determines the first non-wetted region by analyzing the image 31, and calculates the first non-wetted area. The first non-wetted area is the maximum value among individual first non-wetted regions that continuously spread in the first determination region 41. In other words, the first non-wetted area is the area of the largest first non-wetted region in the first determination region 41, rather than the total of the areas of one or more first non-wetted regions in the first determination region 41.

In step S23, the determination unit 13 calculates the ratio of the first non-wetted area to the first region area as the first non-adhesion ratio.

In step S24, the determination unit 13 compares the first non-adhesion ratio with the threshold value Td. This comparison is an example of determining the first degree of adhesion. The threshold value Td may be set to any value, for example, 15%.

When the first non-adhesion ratio is greater than or equal to the threshold value Td (YES in step S24), in step S25, the image analysis unit 12 determines the second non-wetted region by analyzing the image 31, and calculates the second non-wetted area. The second non-wetted area is the maximum value among individual second non-wetted regions that continuously spread in the second determination region 42. In other words, the second non-wetted area is the area of the largest second non-wetted region in the second determination region 42, rather than the total of the areas of one or more second non-wetted regions in the second determination region 42.

In step S26, the determination unit 13 calculates the ratio of the second non-wetted to the second region area as a second non-adhesion ratio.

In step S27, the determination unit 13 compares the second non-adhesion ratio with the threshold value Te. This comparison is an example of determining the second degree of adhesion. The threshold value Te may be set to any value; for example, 15%. The threshold value Te may be the same as or different than the threshold value Td.

When the second non-adhesion ratio is less than the threshold value Te, in step S28, the output unit 14 outputs determination information. This determination information is determination information on both the first degree of adhesion and the second degree of adhesion. In particular, the determination information in step S28 indicates that both adhesion in the first determination region and adhesion in the second determination region are suitable (there is no problem in adhesion in either the first or second determination regions).

FIG. 8 illustrates an example of the determination information output in step S28. In this example, the output unit 14 displays the image 31, the test conditions 32, and the determination result 33 on the display 105. The image 31 and the determination result 33 are equivalent to determination information. The image 31 includes the first determination region 41, which is the entirety of the adhered surface 20, the second determination region 42, which is located in the uppermost row (1×10 block group) of the virtual grid 40, and the determined non-wetted region 43. The non-wetted region 43 within the first determination region 41 is the first non-wetted region, and the non-wetted region 43 within the second determination region 42 (negligible in the example of FIG. 8) is the second non-wetted region. The output unit 14 displays the image 31, which has been processed so as to make these non-wetted regions 43 visible, as a result image. The text “First determination region: Good (82%)” in the determination result 33 is determination information on the first degree of adhesion, and indicates that the first degree of adhesion is “good” based on the first adhesion ratio of 82% and the fact that the first non-adhesion ratio is less than the threshold value Td. The text “Second determination region: Good (92%)” is determination information on the second degree of adhesion, and indicates that the second degree of adhesion is “good” based on the second adhesion ratio of 92% and the fact that the second non-adhesion ratio is less than the threshold value Te.

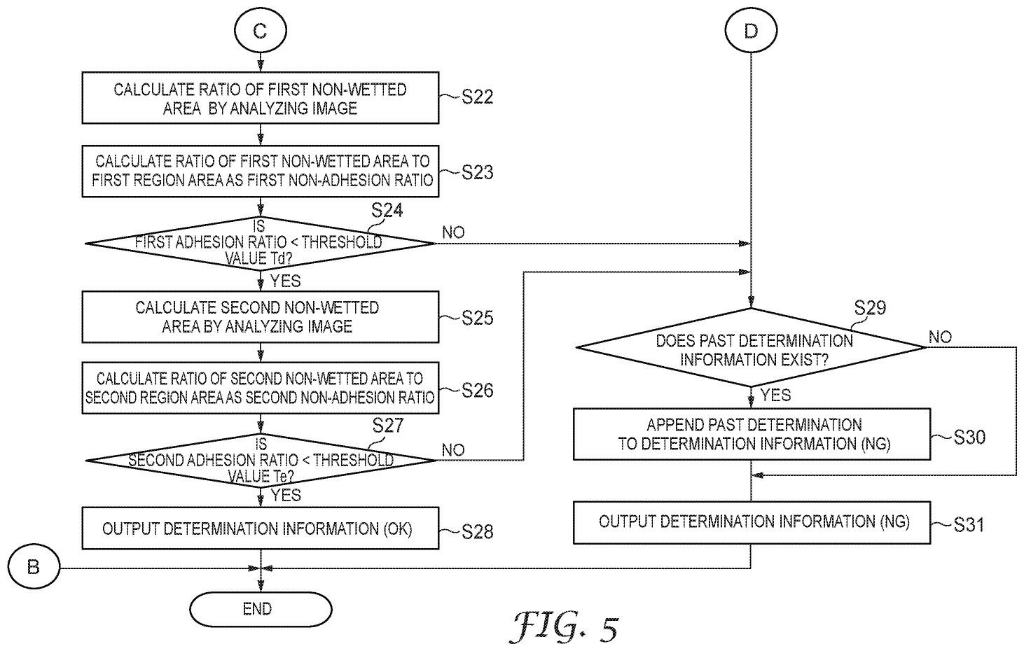

Returning to FIGS. 4 and 5, when the first adhesion ratio is less than the threshold value Tb (NO in step S18), the second adhesion ratio is less than the threshold value Tc (NO in step S21), the first non-adhesion ratio is greater than or equal to the threshold value Td (NO in step S24), or the second non-adhesion ratio is greater than or equal to the threshold value Te (NO in step S27), the process proceeds to step S29. In step S29, the output unit 14 determines whether past determination information exists. The past determination information is determination information obtained when the currently tested adhered surface was previously tested. The output unit accesses locations where past determination information could be stored (for example, the auxiliary storage unit 103 or another computer), and ascertains whether there is past determination information.

When past determination information exists (YES in step S29), in step S30, the output unit 14 appends the past determination information to the current determination information, and in step S31, outputs the current determination information. In a case where past information exists, it means that the current determination corresponds to the second test or beyond. In a case where past determination information does not exist (NO in step S29), the process moves to step S31, and the output unit 14 outputs the current determination information without appending past determination information. In either case, this determination information relates to both the first degree of adhesion and the second degree of adhesion. Unlike the determination information in step S28, the determination information in step S31 indicates that adhesion is unsuitable (there is a problem in adhesion) in the first determination region or the second determination region. Similar to the process in step S28, the output unit 14 may output determination information by any technique.

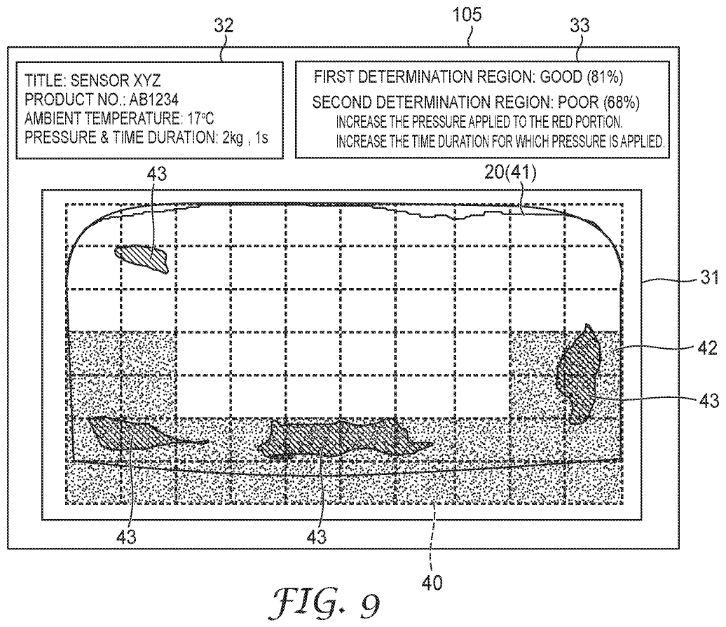

FIG. 9 illustrates an example of the determination information output in step S31. In this example, the output unit 14 displays the image 31, the test conditions 32, and the determination result 33 on the display 105. The image 31 and the determination result 33 are equivalent to determination information. The image 31 includes the first determination region 41, which is the entirety of the adhered surface 20, the C-shaped second determination region 42, which is located on the bottom side of the virtual grid 40, and the determined non-wetted region 43. The non-wetted region 43 within the first determination region 41 is the first non-wetted region, and the non-wetted region 43 within the second determination region 42 is the second non-wetted region. In this example as well, the image 31 is a result image processed so as to make the non-wetted regions 43 visible. The text “First determination region: Good (81%)” in the determination result 33 is determination information on the first degree of adhesion, and indicates that the first degree of adhesion is “good” based on the first adhesion ratio of 81% and the fact that the first non-adhesion ratio is less than the threshold value Td. The text “Second determination region: Poor (68%)” is determination information on the second degree of adhesion, and indicates that the second degree of adhesion is “poor” based on the second adhesion ratio of 68%. The text “Increase the pressure applied to the red portion. Increase the duration for which the pressure is applied” indirectly indicates the extent of adhesion. Thus, it can be considered to be determination information on the second degree of adhesion. Note that the “red portion” means the non-wetted region 43, and similarly in the examples below. The output unit 14 may display the message “Increase the pressure applied to the red portion” on the first determination region side in a case where the first determination region is poor, and may display the message on the second determination region side in a case where the first determination region is good but the second determination region is poor, and may not display the message in a case where both the first determination region and the second determination region are good.

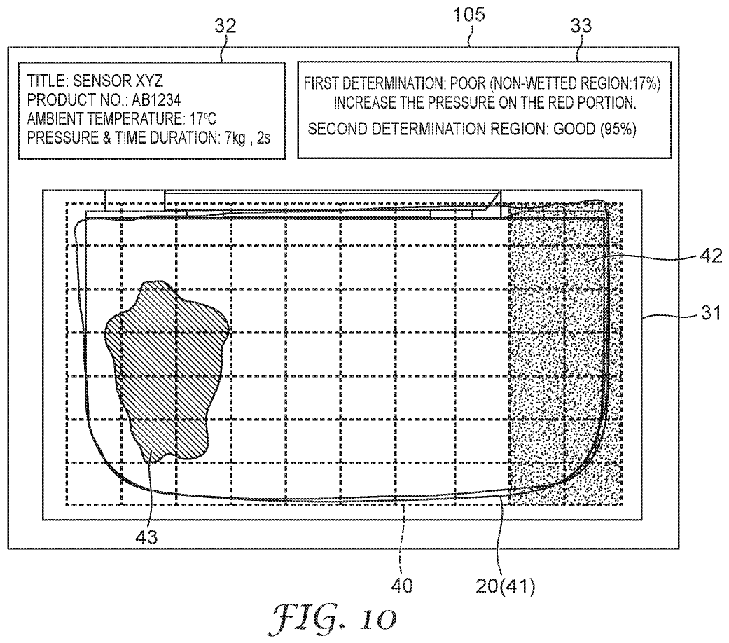

FIG. 10 illustrates another example of the determination information output in step S31. In this example, the output unit 14 displays the image 31, the test conditions 32, and the determination result 33 on the display 105. The image 31 and the determination result 33 are equivalent to determination information. The image 31 includes the first determination region 41, which is the entirety of the adhered surface 20, the second determination region 42, which corresponds to the two right columns (7×2 block group) of the virtual grid 40, and the determined non-wetted region 43. In this example as well, the image 31 is a result image processed so as to make the non-wetted regions 43 visible. The text “First determination region: Poor (17%)” in the determination result 33 is determination information on the first degree of adhesion, and indicates that the first degree of adhesion is “poor” based on the fact that the first non-adhesion ratio is greater than or equal to the threshold value Td. The text “Increase the pressure applied to the red portion” indirectly indicates the extent of adhesion. Thus, it can be considered to be determination information on the first degree of adhesion. The text “Second determination region: Good (95%)” is determination information on the second degree of adhesion, and indicates that the second degree of adhesion is “good” based on the second adhesion ratio of 95% and the fact that the second non-adhesion ratio is less than the threshold value Te.

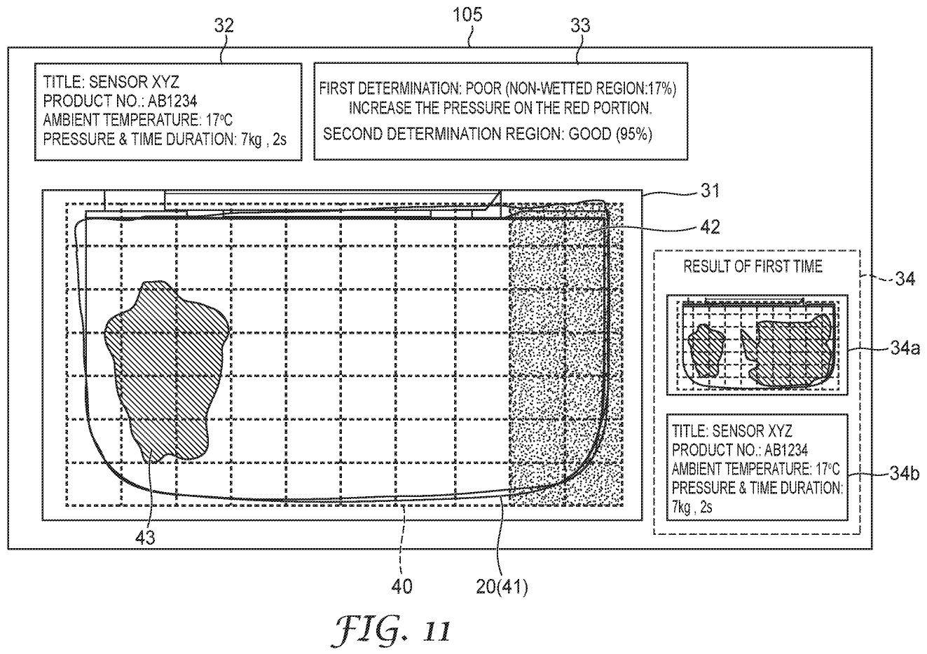

FIG. 11 illustrates yet another example of the determination information output in step S31. In this example, the output unit 14 displays the image 31, the test conditions 32, the determination result 33, and past determination information 34 on the display 105. The image 31 and the determination result 33 are equivalent to determination information. The current determination information constituted of the image 31, the test conditions 32, and the determination result 33 is the same as in the example of FIG. 10. The past determination information 34 includes an image 34a and test conditions 34b.

Past determination information does not have to be output. Thus, the information processing system 10 may omit the processes of steps S29 and S30 and may output determination information that indicates only the current determination result, even in a case where there is past determination information. In the example of FIG. 11, the past determination information 34 is the determination result of one past determination, but the past determination information 34 may be determination results spanning a plurality of past determinations.

### Program

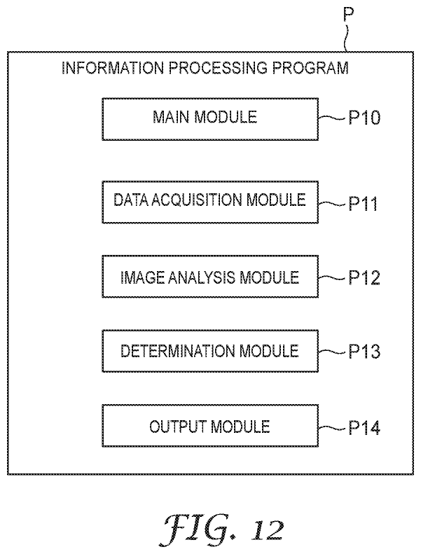

An information processing program P for making a computer system function as the information processing system 10 will be described below with reference to FIG. 12. FIG. 12 is a diagram illustrating a configuration of the information processing program P.

The information processing program P includes a main module P10, a data acquisition module P11, an image analysis module P12, a determination module P13, and an output module P14. The main module P10 integrally controls the functions of the information processing system 10. The data acquisition unit 11, the image analysis unit 12, the determination unit 13, and the output unit 14 are realized by execution of the data acquisition module P11, the image analysis module P12, the determination module P13, and the output module P14.

The information processing program P may be provided after being recorded statically on a physical recording medium such as, for example, a CD-ROM, DVD-ROM, semiconductor memory, or the like. Alternatively, the information processing program P may be provided via a communication network as a data signal superimposed on a carrier wave.

### Effect

As described above, the information processing method according to one aspect of the present invention is an information processing method executed by a processor, the method including calculating a first region area of a first determination region and a first wetted area of the first determination region by analyzing an image in which the first determination region of an adhered surface is projected; determining a first degree of adhesion in the first determination region based on the first region area and the first wetted area; and outputting determination information on the determined first degree of adhesion.

The information processing program according to one aspect of the present invention is an information processing program executed in a computer system, the program including calculating a first region area of a first determination region and a first wetted area of the first determination region by analyzing an image in which the first determination region of an adhered surface is projected; determining a first degree of adhesion in the first determination region based on the first region area and the first wetted area; and outputting determination information on the determined first degree of adhesion.

The information processing system according to one aspect of the present invention includes an analysis unit configured to calculate a first region area of a first determination region and a first wetted area of the first determination region by analyzing an image in which the first determination region of an adhered surface is projected; a determination unit configured to determine a first degree of adhesion in the first determination region based on the first region area and the first wetted area; and an output unit configured to output determination information on the determined first degree of adhesion.

In this aspect, by just preparing an image projected in which the region of the joined surface that is the subject of determination (first determination region) is projected, the degree of adhesion of that region is automatically determined based on that image. Thus, the extent of adhesion of a joined surface can be more simply determined.

In an information processing method according to another aspect, the first determination region is the entirety of the adhered surface or a portion of the adhered surface. In other words, the extent of adhesion for any portion of the adhered surface can be determined.

An information processing method according to another aspect may further include calculating, as a first non-wetted area, an area of a first non-wetted region that continuously spreads within the first determination region by analyzing an image, and additionally, determining a first degree of adhesion based on the first non-wetted area. When regions not joined to the other article are of a certain size or greater, adhesion between the articles may be insufficient. Thus, the extent of adhesion of the adhered surface can be determined more accurately by taking into consideration not only the area of the wetted regions but also the area of the non-wetted regions.

In an information processing method according to another aspect, the determination information may include a result image which makes the first non-wetted region visible. Inclusion of the result image in the determination information allows the user to easily understand which portions are insufficiently adhered.

An information processing method according to another aspect may further include accepting a portion of the first determination region as a second determination region, calculating a second region area of a second determination region and a second wetted area of the second determination region, determining a second degree of adhesion in the determination region based on the second region area and the second wetted area, and outputting determination information on the determined second degree of adhesion. The extent of adhesion of the adhered surface can be determined in further detail by also determining the extent of adhesion of the second determination region which is a portion of the first determination region.

An information processing method according to another aspect may further include displaying a virtual grid superimposing the image on a display, and in the accepting, one or more blocks selected by a user within the virtual grid may be accepted as the second determination region. Employing an interface that uses such a virtual grid allows the user to easily select the second determination region.

An information processing method according to another aspect may further include calculating, as a second non-wetted area, an area of a second non-wetted region that continuously spreads within the second determination region by analyzing an image, and additionally, determining a second degree of adhesion based on the second non-wetted area. When regions not joined to the other article are of a certain size or greater, adhesion between the articles may be insufficient. Thus, the extent of adhesion of the adhered surface can be determined more accurately by taking into consideration not only the area of the wetted regions but also the area of the non-wetted regions.

In an information processing method according to another aspect, the determination information may include a result image which makes the second non-wetted region visible. Inclusion of the result image in the determination information allows the user to easily understand which portions are insufficiently adhered.

In an information processing method according to another aspect, predetermined information may be output without the first degree of adhesion being determined when an ambient temperature input in association with the image is less than a threshold value. Ambient temperature affects adhesion, and therefore determining the extent of adhesion is meaningless when the ambient temperature during adhesion is unsuitable. Outputting prescribed information without performing determination in a case where the ambient temperature does not satisfy a predetermined condition can omit useless determination processing by the processor and also can promote the user to retry adhesion.

In an information processing method according to another aspect, in the output step, determination information and past determination information may be output. Outputting past determination information can present differences from past adhesion (for example, improved portions) to the user.

### MODIFICATION EXAMPLES

Detailed descriptions of the present invention were given above based on embodiments thereof. However, the present invention is not limited to the above embodiments. The present invention may be variously modified within a scope that does not deviate from the spirit of the invention.

The information processing system 10 may determine the degree of adhesion taking into consideration the number of non-wetted regions. The information processing system 10 use this determination technique for either one or both of the first determination region and the second determination region. Specifically, the determination unit 13 determines the non-adhesion ratio for individual non-wetted regions, and determines the number of non-wetted regions in which the non-adhesion ratio is greater than or equal to a threshold value. When the number of non-wetted regions is two or more (that is, when a plurality of non-wetted regions are present), the output unit 14 outputs the same determination information as in step S31. When the number of non-wetted regions is one or fewer, it outputs the same determination information as in step S28.

Examples of output in the examples illustrated in FIGS. 9 and 10 will be described for the case where the information processing system 10 has executed this modification for the second determination region. In the example of FIG. 9, there exist a plurality of second non-wetted regions in which the second non-adhesion ratio is greater than or equal to the threshold value Te, and therefore the output unit 14 displays the message “Increase the duration for which pressure is applied”. In contrast, in the example of FIG. 10, the number of second non-wetted regions in which the second non-adhesion ratio is greater than or equal to the threshold value Te is one or fewer (specifically, zero), and therefore the output unit 14 displays the message “Increase the duration for which pressure is applied”.

In the above embodiments, when the ambient temperature is less than the threshold value Ta, the information processing system 10 outputs predetermined information without determining the first degree of adhesion and the second degree of adhesion, but it does not have to determine ambient temperature. Specifically, the information processing system 10 may determine the first degree of adhesion or the second degree of adhesion unconditionally without determining ambient temperature.

In the above embodiments, the information processing system 10 determines both the first degree of adhesion and the second degree of adhesion, but the information processing system may determine only the first degree of adhesion without determining the second degree of adhesion.

In the above embodiments, the information processing system 10 determines the degrees of adhesion taking into consideration non-wetted regions, but it does not have to perform processing related to non-wetted regions. Specifically, the information processing system 10 may determine the first degree of adhesion without using the first non-wetted area and may determine the second degree of adhesion without using the second non-wetted area.

As described above, the first determination region may be a portion of the adhered surface. When the first determination region is a portion of the adhered surface, the information processing system 10 may acquire the first determination region based on user input, similar to the second determination region in the above embodiments. For example, the information processing system may acquire the first determination region by accepting user input via the virtual grid 40, or may acquire a region within a frame drawn by the user using a pointing device on the image 31 as the first determination region.

The processing procedure of the information processing method executed by one or more processors is not limited to the examples described in the above embodiments. For example, some of the steps (processes) described above may be omitted, or the steps may be executed in a different sequence. Furthermore, any two or more steps among the steps described above may be combined, and some of the steps may be altered or eliminated. Alternatively, other steps in addition to the above steps may also be executed.

In the information processing system according to the present invention, when comparing the magnitudes of two numeric values, either of the criteria “greater than or equal to” or “larger than” may be used, and either of the criteria “less than or equal to” or “less than” may be used. Which of the criteria is selected does not change the technical import of the process of comparing the magnitudes of two numeric values.

1. An information processing method executed by a processor, the method comprising:
detecting a first determination region and a first wetted region in the first determination region by analyzing a projected image including an adhered surface;
calculating a first region area of the first determination region and a first wetted area of the first wetted region by analyzing the image;
determining a first degree of adhesion in the first determination region based on the first region area and the first wetted area;
calculating a second region area of a second determination region in the first determination region, and calculating a second wetted area of a second wetted region in the second determination region;
determining a second degree of adhesion in the second determination region based on the second region area and the second wetted area; and outputting determination information including the determined first degree and its related text message based on the determined first degree of adhesion, and the determined second degree and its related text message based on the determined second degree of adhesion.

2. (canceled)

3. An information processing method executed by a processor according to claim 1, the method comprising:
detecting a first determination region and a first non-wetted region in the first determination region by analyzing a projected image including an adhered surface,
calculating a first region area of the first determination region and a first non-wetted area of the first non-wetted region by analyzing the image; and
determining a first degree of adhesion in the first determination region based on the first region area and the first non-wetted area
calculating a second region area of a second determination region in the first determination region, and calculating a second non-wetted area of a second non-wetted region in the second determination region;
determining a second degree of adhesion in the second determination region based on the second region area and the second non-wetted area; and
outputting determination information including the determined first degree and its related text message based on the determined first degree of adhesion, and the determined second degree and its related text message based on the determined second degree of adhesion.

4. The information processing method according to claim 3, wherein the determination information includes a result image making the first non-wetted area visible.

5. (canceled)

6. The information processing method according to claim 1, the method further comprising:
displaying a virtual grid superimposing the image on a display; and
accepting input of one or more blocks selected by a user within the virtual grid as the second determination region.

7. The information processing method according to claim 1, the method further comprising:
calculating, as a second non-wetted area, an area of a second non-wetted region continuously spreading within the second determination region by analyzing the image; and
determining the second degree of adhesion based on the second non-wetted area, second region area and the second wetted area.

8. The information processing method according to claim 7, wherein the determination information includes a result image making the second non-wetted area visible.

9. The information processing method according to claim 1, the method further comprising outputting predetermined information without determining the first degree of adhesion when an ambient temperature input in association with the image is less than a threshold value.

10. The information processing method according to claim 1, wherein, in the output step, the determination information and past determination information are output.

11. (canceled)

12. (canceled)

13. The information processing method according to claim 3, the method further comprising:
displaying a virtual grid superimposing the image on a display; and
accepting input of one or more blocks selected by a user within the virtual grid as the second determination region.
